(19) United States
(12) Patent Application Publication
(10) Pub. No.: US 2007/0210592 A1
(43) Pub. Date: Sep. 13, 2007

(54) Method and Device for Reinforcing a Hollow Section with a Sealed Periphery

(76) Inventors: Joerg Koelln, Neu Wulmstorf (DE); Jens Schult, Stelle-Ashausen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/582,157

(22) PCT Filed: Nov. 10, 2004
(86) PCT No.: PCT/EP04/12691

§ 371 Date: May 15, 2007

(30) Foreign Application Priority Data
Dec. 9, 2003 (DE) 103 57 343.7

(51) Int. Cl. B60R 19/18

(52) U.S. Cl. 293/122

(57) ABSTRACT

The invention relates to a method and a device for reinforcing a hollow section (1, 24) having a closed periphery, an opening (2) being produced at its periphery, after which a reinforcing component introduced into the hollow section interior (8, 25) is joined to the hollow section wall (11, 27) opposite the opening (2). In order to reinforce the hollow section (1, 24) as easily as possible, it is proposed that, at the location of the opening (2) to be produced, a wall piece (7, 23), forming the reinforcing component, of the hollow section (1, 24) be cut out except for a peripheral region, that the wall piece (7, 32) hanging in one piece on the opening edge (9) be bent into the hollow section (1, 24), with the opening (2) being formed. The length of the wall piece (7, 23) is dimensioned relative to the width of the hollow section (1, 24) in such a way that the wall piece (7, 23), with its free end (10, 26), at least comes into contact with the opposite hollow section wall (11, 27), and the free end (10, 26) is then joined to the hollow section wall (11, 27).

### BACKGROUND AND SUMMARY OF THE INVENTION

This invention relates to a method of reinforcing a hollow section having a closed periphery.

A method or device of this general type is known from German document DE 100 29 467 C1. In the known method, an opening is created on a finish-formed hollow section, after which a reinforcing component is introduced into the hollow section interior through the opening produced. The reinforcing component is then welded to the opening edge on the one hand and to the hollow section wall opposite the opening on the other hand. The known method involves some effort. Thus, the reinforcing component must be aligned exactly relative to the hollow section, then inserted and held in its position during the joining operation.

The object of the invention is to develop a method of the type mentioned in which the hollow section is reinforced as easily as possible. Furthermore, a device with which the reinforcement is achieved is to be shown. The object is achieved according to the invention by the claimed method and by the claimed device.

Thanks to the invention, no additional component is necessary in order to provide the reinforcing component. On the contrary, the reinforcing component is formed from the material of the hollow section itself, to be precise by the wall piece which is cut out for forming the opening. However, this wall piece is only cut out up to a peripheral region, so that the reinforcing component formed by said wall piece does not fall into the hollow section interior and is advantageously held in a defined position by the hollow section itself after the perforating punch plunges into the hollow section interior, during which the wall piece is bent into the latter. All holding and clamping devices for the reinforcing component with regard to the subsequent joining operation can therefore be dispensed with. The reinforcing component, that is to say the wall piece, is introduced into the hollow section interior in an extremely simple manner by bending over the wall piece by means of the perforating punch, which has to plunge into the hollow section interior anyway in order to perforate or cut out the wall piece. To this end, it is merely necessary to specifically design the end face of the punch, so that the punch does not cut out the complete periphery of the wall piece, a bending contour formed on it carrying out the bending operation during the plunging of the punch. Since the reinforcing component according to the invention, with one end, is already connected in one piece to the hollow section, the effort involved for joining it there to the hollow section can be dispensed with. In this case, only one joining device is required, by means of which the free end of the wall piece, which projects into the hollow section interior, can be joined to the opposite hollow section wall. It may be noted at this point that the method according to the invention can only fulfill its function when the distance between the opening on the hollow section and the opposite hollow section wall is equal to or less than the length of the cut-out wall piece. That is to say that the free end of the wall piece must come into contact with said hollow section wall at least in a right-angled bent form. In the method according to the invention, hollow sections can therefore be specifically reinforced locally and can thus be adapted individually to different loading profiles. On the whole, the local rigidity of hollow sections, in particular of components formed by internal high pressure, can be increased by the invention without additional use of material. The finish-formed and reinforced component is in this case more rigid at the same weight. In addition, the net output is increased by the integration in the internal high pressure forming process. Additional production steps can be dispensed with, as can additional components.

In an especially preferred development of the invention, the wall piece is oversize with regard to its length relative to the width of the hollow section. The wall strip projecting here is bent over inside the hollow section by means of a punch plunging into the opening and is brought to bear against the hollow section wall in such a way as to conform to the contour, after which this wall strip is joined to the hollow section wall. On account of the essentially larger dimensions of available joining area compared with point or linear contact by the wall strip, firstly the joining operation is facilitated and the hold, resulting from the joining operation, between the reinforcing component and the hollow section is considerably increased when the available joining area is fully utilized. Furthermore, to carry out the joining, joining methods may also be used which would not have been advisable with the reinforcing component only in abutting contact with the hollow section wall on account of a lack of functionality. To this end, the end face of the perforating punch is to be designed with a cutout which extends from the bending contour in the direction of the cutting edge and has in its depth at most the wall thickness of the wall piece and corresponds in its contour essentially to the wall strip which is to be bent over, so that the latter can be readily folded by the perforating punch and pressed against the hollow section wall. This is expressed in the preferred development of the device according to the invention.

In a further, especially preferred configuration of the invention, the joining operation is effected by means of press joining. In this special joining method, the wall strip can be fastened to the hollow section wall especially simply and quickly, the hold of the wall strip on the hollow section wall being especially good on account of the virtually permanent mechanical clamping.

In a further, especially preferred configuration of the device according to the invention, the press-joining device contains a joining punch which is movably guided in a passage of the perforating punch, said passage opening out at the cutout at the end face. Furthermore, the press-joining device contains a die which is formed with a recess and bears against the outside of the hollow section, the recess having undercut contours and being in alignment with the passage of the joining punch. Due to the step of integrating the joining punch in the perforating punch, not only construction space but also a further work station are saved. Associated therewith, the process time for producing and for reinforcing the hollow section having a closed periphery is considerably reduced, since the transfer path into the joining station otherwise necessary is dispensed with. Furthermore, production tolerances which arise during the transfer from one work station to the other are prevented. Furthermore, the wall strip of the wall piece remains exactly positioned for the press-joining method, since the perforating punch holds the wall strip on the hollow section wall during the entire press-joining method.

A further preferred configuration of the device according to the invention relates to the integration of the perforating punch in an internal high pressure forming tool, in the impression of which the hollow section is accommodated. As a result, the reinforcing component can already be produced during the shaping of the hollow section by means of internal high pressure by virtue of the fact that the perforating punch cuts out the wall piece in the hollow section body being shaped or already finish-formed, in which case sufficiently sound sealing of the perforating punch in the opening must be assumed so that a pressure drop does not occur which would disturb the process for shaping the hollow section and would no longer provide for conformity to contour of the hollow section during a plurality of successive perforations for producing a plurality of spaced-apart reinforcing components. With the integration of the perforating punch and thus the production of the reinforcing component in the internal high pressure forming tool, the entire process for producing the hollow section is simplified in such a way as to save construction space and the production time is reduced. Relatively sharp-edged transitions between the hollow section and the reinforcing component bent into the hollow section interior can be produced by the internal high pressure, a factor which, depending on the intended use, may be necessary for optical reasons for as highly precise an outer contour of the hollow section as possible.

In a further, especially preferred configuration of the invention, the hollow section is formed by internal high pressure, wherein, following the forming in the internal high pressure tool, the opening is formed at existing internal high pressure, the wall piece is bent into the hollow section, and the wall strip is bent over and press-joined to the opposite hollow section wall. To this end, the press-joining device is integrated in the internal high pressure forming tool. As an addition to the above embodiments, the wall strip of the cut-out wall piece is also bent over and press-joined to the hollow section wall, so that the coupling of the production of the hollow section with the forming and fastening of the reinforcing component on the hollow section firstly provides for a highly compact type of construction of the device and minimizes the process time of the method for reinforcing the hollow section and for forming the hollow section.

In the event that only the free end of the reinforcing component comes into contact with the hollow section wall, so that no wall strip can be formed, the reinforcing component, with its free end, is advantageously welded in the form of a fillet weld to the hollow section wall by means of a welding device, which forms the joining device, as a preferred development of the invention.

The invention is explained in more detail below with reference to several exemplary embodiments shown in the drawings.

### BRIEF DESCRIPTION OF THE DRAWINGS

FIG. 1 shows a rough cross section of a hollow section to be reinforced according to the invention, with a device according to the invention for forming the reinforcement when cutting out a wall piece,

FIG. 2 roughly shows the hollow section from FIG. 1, having a reinforcing component bent into the hollow section interior by a perforating punch of the device according to the invention,

FIG. 3 shows a cutaway longitudinal section of the reinforcing component from FIG. 2 bent into the hollow section interior, with a press-joining means of the device according to the invention, with a joining punch acting on the reinforcing component from the hollow section interior, and with a die bearing against the hollow section on the outside for carrying out the press-joining method,

FIG. 4 shows a cutaway longitudinal section of the hollow section with bent-in reinforcing component according to FIG. 2, with a joining die acting upon the reinforcing component from the hollow section interior, and with a joining punch acting on the hollow section from outside for carrying out the press-joining method,

FIG. 5 shows a cross section of a hollow section reinforced according to the invention and having a closed periphery, with a wall strip welded to the hollow section wall,

FIG. 6 shows a cross section of a hollow section reinforced according to the invention and having a closed periphery, with a wall strip press-joined to a hollow section wall,

FIG. 7 shows, in a rough illustration, a hollow section, to be reinforced according to the invention, in the phase during which an opening is produced on the hollow section by means of a perforating device according to the invention,

FIG. 8 shows, in a rough illustration, the hollow section from FIG. 7, with a perforating device plunged into the hollow section interior and with the bending-in of the reinforcing component, and

FIG. 9 shows a cross section of the finish-reinforced hollow section according to FIGS. 7 and 8, with a fillet weld of the free end, abutting against the hollow section wall, of the reinforcing component.

### DETAILED DESCRIPTION OF THE INVENTION

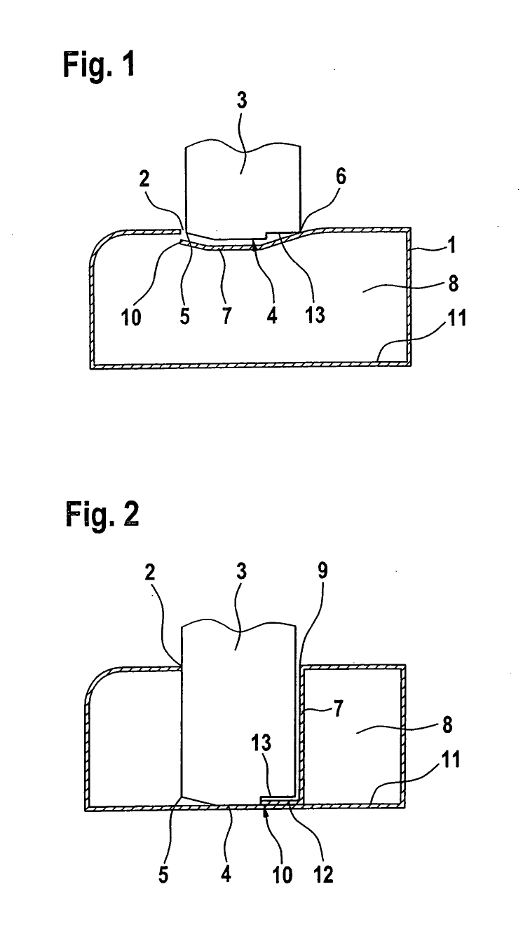

A hollow section 1 which has a closed periphery and is to be locally reinforced is shown in FIG. 1. To this end, a tool is used, by means of which an opening 2 is formed on the periphery of the hollow section. The tool may be a jet cutter, such as a laser cutting apparatus for example, but is formed here by a perforating punch 3, which is directed from outside onto the hollow section 1. At the end face 4 of the perforating punch 3, a cutting edge 5 is arranged around part of the periphery, whereas the rest of the periphery of the end face 4 of the punch 3 has a bending contour 6. In FIG. 1, a wall piece 7 which is to form the reinforcing component is cut out of the hollow section by the perforating punch 3, except for a narrow bendable peripheral region. In the present exemplary embodiment, the wall piece 7 has oversize with regard to its length, relative to the width of the hollow section 1.

After the wall piece 7 has been cut out, the perforating punch is moved still further toward the hollow section 1, as a result of which the perforating punch 3 plunges into the hollow section interior 8. In the process, the perforating punch 3, with its bending contour 6, bends the wall piece 7, hanging in one piece on the opening edge 9, into the hollow section interior 8, as a result of which the opening 2 is formed, which, however, is closed here by the perforating punch 3 until it is retracted from the hollow section 1. As a result, the perforating punch 3 forms the means for introducing the reinforcing component into the interior 8 of the hollow section 1. The wall piece 7, with its free end 10, after sweeping a bending angle which is less than 90°, comes into contact with the opposite hollow section wall 11 on account of the oversize of the wall piece 7.

The perforating punch travels further until it runs against the hollow section wall 11, as a result of which the wall piece 7 bends in at the locations at which the wall piece 7 projects relative to the width of the hollow section 1. The wall strip 12, forming in the process, of the wall piece 7 is brought to bear against the hollow section wall 11 by the end face 4 of the perforating punch 3 in such a way as to conform to the contour, the rest of the wall piece 7 now running from the opening edge 9 at a 90° angle toward the hollow section wall 11. In order to avoid a situation in which the wall strip 12 tears when being bent over and the hollow section wall 11 is crushed in a damaging manner, the perforating punch 3, at its end face 4, has a cutout 13 which starts from the bending contour 6 and is designed in its shape and dimensions in such a way that the wall strip 12 is accommodated when being bent over and when being brought to bear. In this case, the cutout 13 has a depth which corresponds to the wall thickness of the wall strip 12.

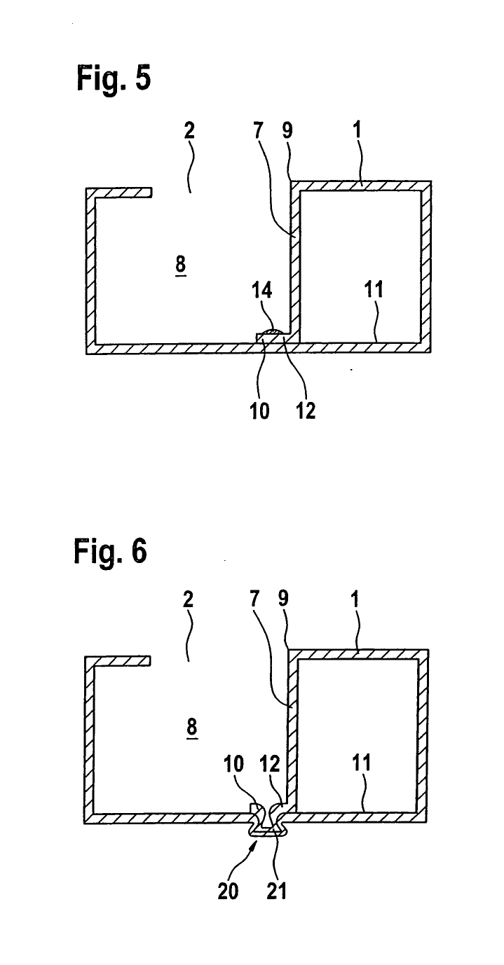

Finally, the wall strip 12 is joined to the hollow section wall 11. A plurality of variants of joining methods are conceivable here. For example, the wall strip 12 according to FIG. 5 can be fixed to the hollow section wall 11 by a welding method, preferably by spot welding, with a plurality of weld spots 14 being formed, or in other welding operations with a weld being formed. Furthermore, mechanical clamping of the wall strip 12 to the hollow section wall 11 by a press-joining method is also very favorable. In the joining operation, combinations of press joining and welding are also possible, it being possible for the two methods to be effected in parallel or successive processing steps.

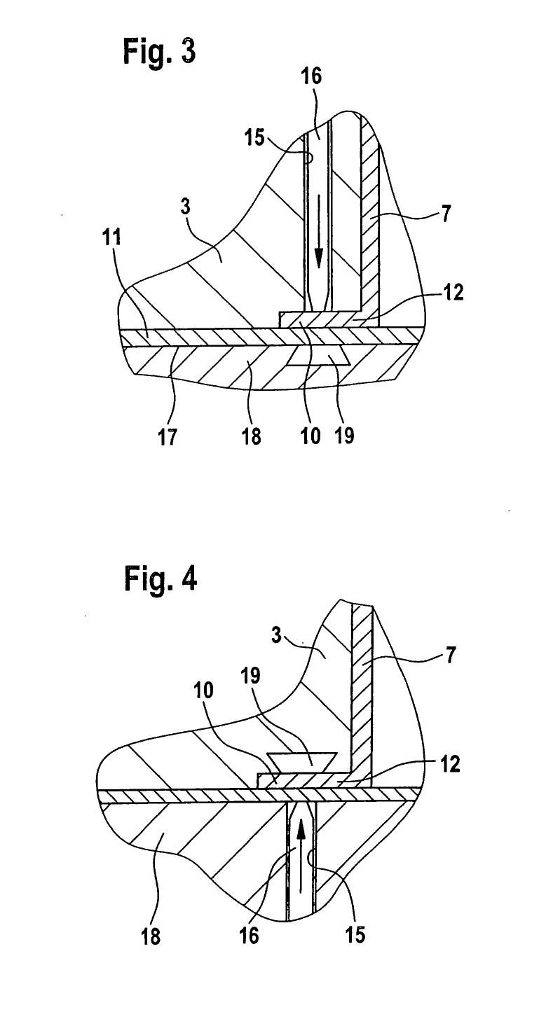

To carry out the press-joining method, the perforating punch 3 has an axial passage 15 which opens out at the cutout 13 at the end face. A joining punch 16 according to FIG. 3 is movably guided in the passage 15, as illustrated by the arrow. A die 18 of the press-joining device bears against the outside 17 of the hollow section wall 11, this die 18 having a recess 19 with dovetailed undercut contours. In its position of use, the recess 19 of the die 18 is in alignment with the passage 15 of the joining punch 16. The descending joining punch 16 now applies pressure to the wall strip 12 bearing against the hollow section wall 11 and presses it at this location together with the underlying region of the hollow section wall 11 into the recess 19 of the die 18. This results according to FIG. 6 in a knob-like joint 20, at which the hollow section wall 11 encloses, in a positive-locking manner, the fastening knob 21 produced from the wall strip 12 by pressing into the recess 19 and provided with undercut contours. Alternatively, it is also conceivable, according to FIG. 4, for the joining punch 16 and the passage 15 to be formed or directed in the die 18. Accordingly, a recess 19 must be formed in an opposite location on the end face 4 of the perforating punch 3, this recess 19 adjoining the cutout 13 to the rear away from the wall strip 12. In this case, the fastening knob 21 is located inside the hollow section 1, which may possibly be advantageous for meeting optical requirements.

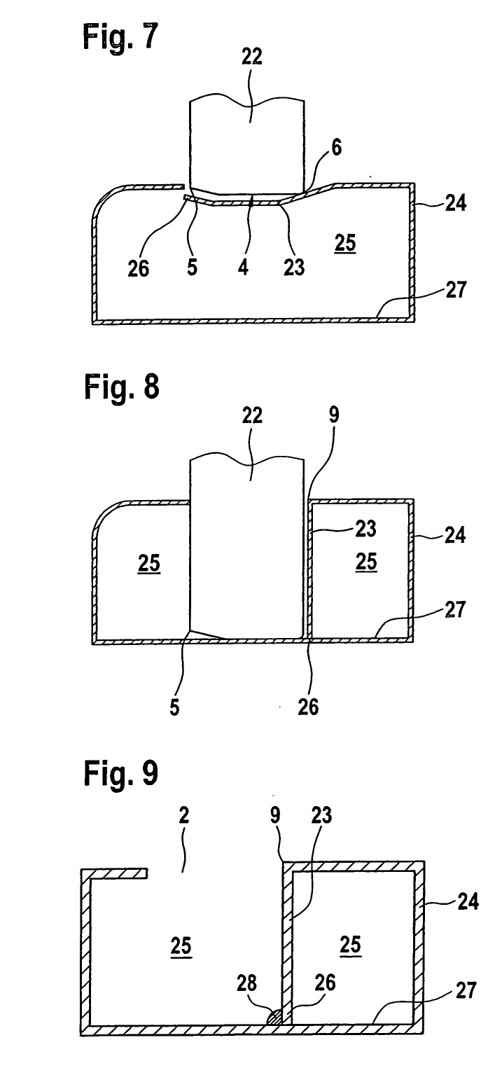

FIGS. 7 to 9 show a further exemplary embodiment of the invention. In deviation from the preceding exemplary embodiment, the perforating punch 22, compared with the perforating punch 3, does not have the cutout 13. Furthermore, a wall piece 23 whose length is just less than the width of the hollow section 24 is cut out here. The wall piece 23 is now cut out according to FIG. 7 by the perforating punch 22 and is bent according to FIG. 8 into the hollow section interior 25 by the plunging perforating punch 22. The wall piece 23 is bent at right angles by the bending-in and its free end 26 comes into contact with the opposite hollow section wall 27. After the withdrawal of the perforating punch 22 from the hollow section interior 25, the free end 26 is welded to the hollow section wall 27 by means of a welding device, preferably using filler material, for example by an arc welding method or plasma welding method, with a fillet weld 28 being formed.

In the above embodiments of the invention, it is in each case conceivable for the hollow section to be subjected to internal high pressure forming. For reasons of economy in relation to the method, it is favorable here to integrate the perforating punch 3 or 22 and also the press-joining device in the internal high pressure forming tool. The die 18 of the press-joining device may in this case be formed by the impression of the forming tool in which the hollow section 1 or 24 is accommodated.

1-12. (canceled)

13. A method of reinforcing a hollow section having a closed periphery, an opening being produced at its periphery, after which a reinforcing component introduced into the hollow section interior is joined to the hollow section wall opposite the opening, comprising:
cutting a wall piece, forming the reinforcing component, of the hollow section out at the location of the opening to be produced except for a peripheral region,
bending the wall piece hanging in one piece on the opening edge into the hollow section, with the opening being formed, the length of the wall piece being dimensioned relative to the width of the hollow section in such way that the wall piece, with its free end, at least comes into contact with the opposite hollow section wall, and
joining the free end to the hollow section wall.

14. The method as claimed in claim 13, wherein the wall piece is oversize with regard to its length relative to the width of the hollow section, wherein the projecting wall strip is bent over inside the hollow section by means of a punch plunging into the opening and is brought to bear against the hollow section wall in such a way as to conform to the contour, and wherein the wall strip is joined to said hollow section wall.

15. The method as claimed in claim 14, wherein joining is effected by press joining.

16. The method as claimed in claim 13, wherein joining is effected by welding.

17. The method as claimed in claim 15, wherein the hollow section is formed by internal high pressure, and wherein, following forming in the internal high pressure tool, the opening is formed at existing internal high pressure, the wall piece is bent into the hollow section, and the wall strip is bent over and press-joined to the opposite hollow section wall.

18. The method as claimed in claim 14, wherein joining is effected by welding.

19. The method as claimed in claim 15, wherein joining is effected by welding.

20. A device for reinforcing a hollow section having a closed periphery, comprising:
a tool for forming an opening at the periphery of the hollow section,
a means for inserting a reinforcing component into the interior of the hollow section, and
a joining device for connecting the reinforcing component to the hollow section wall opposite the opening,
wherein the tool for forming the opening is a perforating punch, on the end face of which a cutting edge is formed around part of the periphery, the rest of the periphery of the end face of the punch having a bending contour, by means of which a wall piece cut out by the cutting edge except for a peripheral region and forming the reinforcing component can be bent into the hollow section interior, during the plunging of said punch, until the free end of the wall piece bears against the hollow section wall, and
wherein a joining device is provided, by means of which the free end can be joined to the hollow section wall.

21. The device as claimed in claim 6, wherein, after the free end of the wall piece comes into contact with the hollow section wall, a wall strip, containing the free end, of the wall piece can be bent over by means of the perforating punch and brought to bear against the hollow section wall in such a way as to conform to the contour, this wall strip being formed by an oversize of the wall piece with regard to its length relative to the width of the hollow section, and wherein the perforating punch, at the end face, has a cutout which starts from the bending contour and in which the wall strip is accommodated when being bent over and when being brought to bear.

22. The device as claimed in claim 21, wherein the joining device is a welding device.

23. The device as claimed in claim 21, wherein the joining device is a press-joining device, by means of which the wall strip bearing against the hollow section wall can be fastened to the latter.

24. The device as claimed in claim 23, wherein the press-joining device contains a joining punch which is movably guided in a passage of the perforating punch, said passage opening out at the cutout at the end face, and wherein the press-joining device contains a die which is formed with a recess and bears against the outside of the hollow section, the recess having undercut contours and being in alignment with the passage of the joining punch.

25. The device as claimed in claim 20, wherein the perforating punch is integrated in an internal high pressure forming tool, in the impression of which the hollow section is accommodated.

26. The device as claimed in claim 25, wherein the press-joining device is integrated in the internal high pressure forming tool.

27. The device as claimed in claim 21, wherein the perforating punch is integrated in an internal high pressure forming tool, in the impression of which the hollow section is accommodated.

28. The device as claimed in claim 27, wherein the press-joining device is integrated in the internal high pressure forming tool.

29. The device as claimed in claim 22, wherein the perforating punch is integrated in an internal high pressure forming tool, in the impression of which the hollow section is accommodated.

30. The device as claimed in claim 29, wherein the press-joining device is integrated in the internal high pressure forming tool.

31. The device as claimed in claim 23, wherein the perforating punch is integrated in an internal high pressure forming tool, in the impression of which the hollow section is accommodated.

32. The device as claimed in claim 31, wherein the press-joining device is integrated in the internal high pressure forming tool.
